(19) United States
(12) Patent Application Publication
(10) Pub. No.: US 2021/0114141 A1
(43) Pub. Date: Apr. 22, 2021

(54) METHOD FOR LASER SURFACE TREATMENT OF FURNACE FURNITURE

(71) Applicant: TATA STEEL IJMUIDEN B.V., Velsen-Noord (NL)

(72) Inventors: David Thomas Allan MATTHEWS, Borne (NL); Josephus Theodorus Maria DE HOSSON, Marum (NL); Ondrej NENADL, Groningen (NL); Václav OCELÏK, Groningen (NL)

(73) Assignee: TATA STEEL IJMUIDEN B.V., Velsen-Noord (NL)

(21) Appl. No.: 16/463,656

(22) PCT Filed: Nov. 28, 2017
(86) PCT No.: PCT/EP2017/080715

§ 371 Date: May 23, 2019

(30) Foreign Application Priority Data
Dec. 2, 2016 (EP) 16202038.2
Mar. 17, 2017 (EP) 17161655.0

(51) Int. Cl. B23K 26/354; B23K 26/06

(52) U.S. Cl. CPC B23K 26/354; B23K 26/123; B23K 26/0604

(57) ABSTRACT

A method for a laser surface treatment of furnace furniture of a heating furnace, which furnace furniture is used for the support of metal products in the heating furnace, the method including the steps of:
setting a laser device to generate a laser beam of a pre-defined power,
guiding the laser beam over the surface of the furnace furniture with a pre-defined velocity, such that the surface of the furnace furniture is heated locally to above its melting temperature.

### FIELD OF THE INVENTION

The invention relates to a method for laser surface treatment of furnace furniture as used in heating and reheating furnaces used in the steel industry as well as in other industries.

### BACKGROUND OF THE INVENTION

The delivery of steel through (re)heating furnaces requires many peripheral hardware, quite often in the form of rolls, rails, tables, trays, posts, fixtures and other supports to support the travelling strip, slab or part, such as ceramic or metal parts. These different support parts are commonly called “furnace furniture”.

These supports can vary widely in dimensions and application, while the operating atmospheres and temperatures can also vary from furnace to furnace.

The supports are over a smaller or larger surface area in direct contact with the strip, slab or other product, for instance rolls and rails, and as such have to withstand the temperature and atmosphere under which the strip is being processed, coupled with bearing the load of the product being processed, without deteriorating too quickly nor adversely changing the surface of the product with which these supports are in contact.

In compact sheet plants or direct sheet plants the steel slab is transported from the casting section to the roughing rolling mill through a tunnel furnace. In “standard” hot strip mills, slab is transported on rails or other flat supports (either pusher type furnaces or walking beam furnaces). Typically, such furnace furniture are internally water-cooled to ensure the furnace furniture does not degrade structurally at the high operating temperatures of steel (re)heating furnaces, but this incurs high energy losses to the said furnace furniture.

With the application of novel high-temperature creep resistant alloys for furnace furniture it has become possible to operate the furnace furniture at the temperature of the supported product. With that the need to cool the furnace furniture is circumvented, leading to huge energy savings. The downside of the use of these alloys for furnace furniture is that the surface aspects of such novel alloy supports are such that the supports can pick-up slab or strip (oxide) scales, inducing surface defects by virtue of scratches or indents in the supported slab or strip, which manifest as surface or internal defects in downstream processing of the slab, strip or other product.

As the slab or other product touches the supporting furnace furniture and the fact that the furniture is constantly heated in the furnace, a further threat can come from mechanical or chemical adherence of loose scale from the slab or other product being transported to the outer surface of the transport support and leading to damage to the transport support.

### Objectives of the Invention

It is an objective of the present invention to provide a laser surface treatment method of furnace furniture which to a large degree prevents the pick-up of scales from the supported products.

It is an objective of the present invention to provide a laser surface treatment method of furnace furniture which to a large degree prevents damage to the furnace furniture.

It is another objective of the present invention to provide a laser surface treatment method of furnace furniture which can be carried out after the furnace furniture has been manufactured.

It is another objective of the present invention to provide a laser surface treatment method of furnace furniture which can be carried out easily and against low costs.

It is still another objective of the present invention to provide furnace furniture of which at least part of the surface has been treated according to the method.

### DESCRIPTION OF THE INVENTION

The invention relates to a method as defined in claims 1-16.

One or more of the objectives are realised by providing a method for a laser surface treatment of furnace furniture of a heating furnace, which furnace furniture is used for the support of metal products in the heating furnace, the method comprising the steps of:

setting a laser device to generate a laser beam of a pre-defined power,

guiding the laser beam over the surface of the furnace furniture with a pre-defined velocity, such that the surface of the furnace furniture is heated locally to above its melting temperature.

The laser beam is moved with a pre-defined velocity over the surface of the such that the surface is locally re-melted and solidifies almost directly after the laser beam has passed. By the re-melting and solidification of the surface of the high temperature creep resistant alloys the metallurgy and therewith the surface aspects of the laser treated part are modified. It was found that the laser treatment resulted in a refined microstructure, finer grain structure and increased hardness. The effect thereof is that the pick-up of (oxide) scales is greatly reduced, which in tests resulted in a reduction of 80% and more.

In order to treat the total of the surface area of furnace furniture that will be in contact with a high temperature product the laser beam has to be guided over that surface area. This is achieved by moving the laser device and/or the laser beam and the furnace furniture with respect to each other. Both the laser device and the furnace furniture can be moved with respect to each other or only one of the laser device and the furnace furniture can be moved with respect to the other. A further alternative is to only guide the laser beam over said surface area with the laser device and the furnace furniture in stationary position. However this alternative way of guiding the laser beam over a piece of furnace furniture will not be possible with all furnace furniture such as support rolls.

In order to be able to speed up the treatment it is provided that one or more laser devices are used to generate multiple laser beams. Dependent on the shape of the furnace furniture to be treated a simultaneous treatment of a larger part of the furnace furniture will be possible.

According to a further aspect it is provided that the laser beam or multiple laser beams are each guided in a single track or in multiple tracks over the surface of the furnace furniture. Rather than trying to cover a large surface area by complicated movement over the surface it is preferred to guide the laser beams in an easy controllable x,y movement resulting in straight or curved tracks over flat or curved surfaces or in one or more round or helical tracks over the surface of a support roll.

The movement of the laser beams is preferably further controlled such that the tracks of the laser beam or laser beams run parallel to each other. This allows covering the total surface area with a common control factor in controlling the tracks of the laser beam or laser beams.

This control of the laser beam or laser beams further facilitates to have adjacent tracks of the laser beam or laser beams overlap. It is preferred to have the tracks overlap since the power of the laser beam has a certain distribution over the area covered by the beam, which will commonly be a Gaussian distribution. This will result that the temperature over the width of the track will vary and that the degree of re-melting across the width will vary from no re-melting at all to a re-melt to a maximum depth. In the length of the track the degree and depth of re-melting will be the same for corresponding points along the track. By having the parallel tracks overlap the variation in the degree and depth of re-melting can be reduced.

In order to be able to cover a surface area with a reasonably limited number of tracks it is provided that the laser device or the laser devices are controlled such that the generated laser beam or laser beams result in tracks with a width in a range of 1-6 mm, preferably in a range of 2-5 mm.

To get a uniform re-melted surface as much as possible it is provided that the overlap of adjacent tracks of the laser beam or laser beams is in the range of 20-80%, preferably between 40-80% and even more preferably between 60-70%. With the latter overlap of tracks the re-melting is as good as uniform over the treated surface area.

The laser device is controlled to generate either a continuous or a pulsed laser beam or laser beams for use in the method.

The time needed to treat a surface area to a certain depth is dependent on the velocity with which the laser beam is guided over the surface and the power of the laser beam(s). The power of the laser beam or laser beams is controlled and is in a range sufficient to deliver a fluence in a range of 1.3×10⁶-1.3×10⁸ J/m². The power, shape and size of the laser beam is controlled dependent on the velocity of the movement of the laser beam over the surface of the furnace furniture and the given range is sufficient to cover a wide range of velocities.

The velocity of the movement of the laser beam or the laser beams and the furnace furniture with respect to each other is kept in a range of 5-100 mm/s.

With lower velocities less power is needed, however the determining factor is fluence that can be delivered, the energy delivered to a unit surface area.

Good results have been realised with the method wherein the velocity of the movement of the laser beam or the laser beams and the furnace furniture with respect to each other is in the range of 5-50 mm/s and wherein the power of the laser beam or the laser beams is sufficient to deliver a fluence in the range of 1.3×10⁶-1.3×10⁸ J/m².

By increasing the power of the laser beam or laser beams used in the method and delivering a fluence as stated, the velocity and/or the width of the tracks can be increased. The power of the nowadays available laser equipment is in a range of up to 10 kW or even 20 kW enabling to realise a track width of up to 100 mm. Typically this could be done by fast laser beam sweeping transversely to the general direction of movement with regard to the treated part.

To prevent oxidation and/or other reactions at the surface of the processed furnace furniture the laser surface treatment is carried out under a protective atmosphere. According to a further aspect of the method the protective atmosphere is an argon atmosphere.

The method has effectively been applied on furnace furniture made from creep resistant Ni—Cr alloys. More in particular of creep resistant Ni—Cr alloys wherein the Ni+Cr content is in a range of 50-90%, preferably in a range of 75-85%.

After the laser treatment a mechanical surface treatment can be applied as far as necessary, for instance any suitable mechanical polishing operation of the laser treated surface.

### BRIEF DESCRIPTION OF THE DRAWINGS

The invention will be further explained by means of the example shown in the drawing, in which:

FIG. 1 shows a graph of the depth of re-melting at different surface speeds as a function of energy delivered to the surface,

FIG. 2 shows a BSE image of an interface between a re-melted zone (top part) and the bulk material,

FIG. 3 shows a graph microstructure sizes in the re-melted zone for different processing speeds,

FIG. 4 shows a representation of a re-melted zone with processing parameters,

FIG. 5 shows a BSE image of a transition from a thermally affected porous region to the bulk material that has not been re-melted, and

FIG. 6 shows a BSE image of a transition from a thermally affected region in a re-melted zone to a non-re-melted zone and a thermally affected porous region within the re-melted zone.

### EXAMPLE AND DETAILED DESCRIPTION OF THE DRAWINGS

A particular alloy with the composition given in Table 1 has been tested extensively in static and dynamic high temperature oxidation and wear tests, and compared to the standard material/surface.

TABLE 1
Example composition of material tested.

| Element | Ni | Cr | W | Fe | C | Si | Mn |
|---|---|---|---|---|---|---|---|
| wt. % | 45~50 | 30~35 | 10~20 | 1.0~2.0 | 0.35~0.45 | 0.25~0.35 | 0.05~0.15 |

A series of laser processing parameters has been followed utilising a 3 kW continuous wave solid-state fibre laser by IPG Photonics with a wavelength of 1.07 μm, 4 axis CNC table and delivery of a shielding gas (argon). Defocusing of the laser beam was tuned to obtain single laser track width of slightly more than 3 mm.

TABLE 2
Typical laser processing parameters during trials

| Surface Speed (mm/s) | Laser Power (W) |
|---|---|
| 5 | 300-1100 |
| 20 | 1000-1800 |
| 100 | 2000-3000 |

The combination of laser parameters as given in Table 2 can be used to determine the fluence or the energy delivered to the surface of the part being processed in J/m2 which provides an energy density for the process, see Table 3. The test has been carried out on a round bar wherein the round bar is rotated resulting in the given surface speed.

TABLE 3
processing parameters, power density and fluence

| Power | Speed | Beam radius | Power density | Processing | Fluence |
|---|---|---|---|---|---|
| [W] | [mm/s] | [mm] | W/m\hat{ }2 | time [s] | (J/m\hat{ }2) |
| 300 | 5 | 1.5 | 4.24E+07 | 0.6 | 2.55E+07 |
| 1100 | 5 | 1.5 | 1.56E+08 | 0.6 | 9.34E+07 |
| 1000 | 20 | 1.5 | 1.41E+08 | 0.15 | 2.12E+07 |
| 1800 | 20 | 1.5 | 2.55E+08 | 0.15 | 3.82E+07 |
| 2000 | 100 | 1.5 | 2.83E+08 | 0.03 | 8.49E+06 |
| 3000 | 100 | 1.5 | 4.24E+08 | 0.03 | 1.27E+07 |

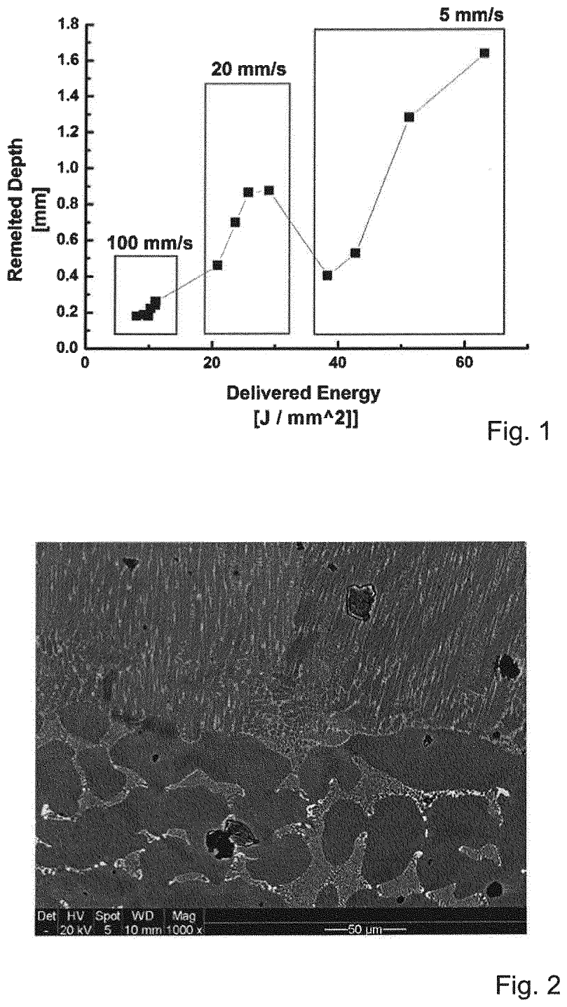

FIG. 1 shows the influence of the changing process parameters, that is the energy delivered on the re-melted depth of the layer formed.

The series of process parameters reveal a good surface quality, without any porosity or cracking and a well-defined interface between re-melted regions and the bulk material. The exception were tracks produced at highest scanning speed 100 mm/s which all had severe cracking.

The given composition is characterised by a cast microstructure having a dendritic microstructure with eutectic solidified between the dendrites. Laser re-melting results in a considerable decrease in the size of the dendrites for all scanning speeds and laser powers.

FIG. 2 shows an energy dispersive x-ray spectroscopy (EDS) image of an interface between a re-melted zone and the bulk material. It shows that additionally to a dendritic microstructure, a columnar microstructure is found in some regions after re-melting, especially close to an interface between the re-melted layer and the original bulk material.

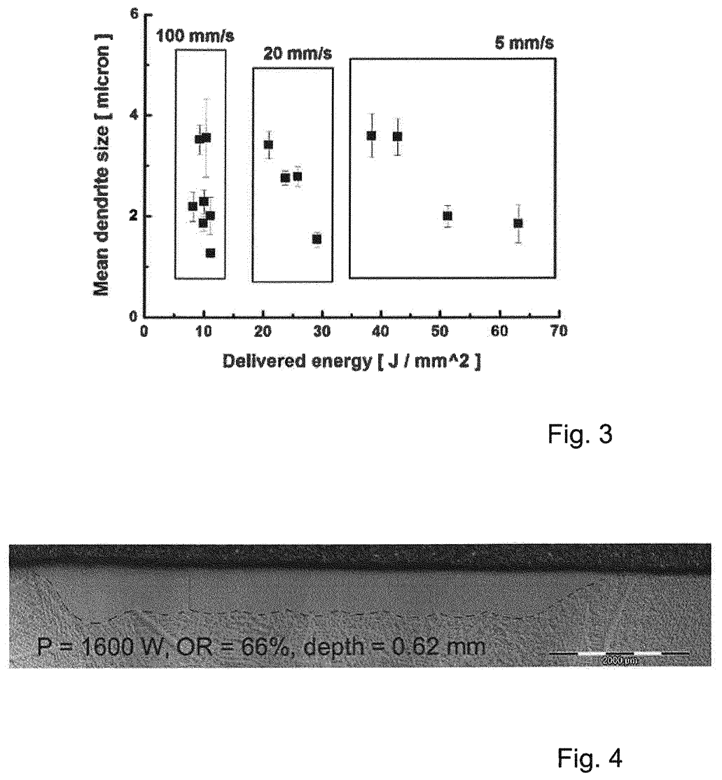

FIG. 3 shows a graph of the refinement of the microstructure characterised by the mean dendrite size. It shows that in general the microstructure has become finer by about an order of magnitude and this does not change much for the different processing parameters. Further it can be seen from that for each set of speeds there is a small decrease in the size of the microstructure with increased laser power.

By overlapping the tracks of individual re-melted tracks re-melted layers can be formed of any length and width. The depth of such layers is determined as the minimum amount of re-melted depth corresponding to overlapped regions. FIG. 4 reveals one such layer produced with a power P=1600 W, overlap OR=66% and velocity S=20 mm/s resulting in a re-melting depth of 0.62 mm. Experiments show that the depth can be increased by increased laser power and/or by increasing the overlap.

A combination of EDS mapping and electron back-scattered diffraction (EBSD) has been used to identify individual phases present on a micro-scale. Ni and Fe predominantly forms the dendrites and Cr, W and Mn have a higher concentration in the eutectic where this phase alternates with the Ni-rich phase. Further, it has been shown that carbon is more abundant in the chromium and tungsten rich phases, forming carbides. The main phases are Ni solid solution, Cr—C phase(s) and W—C phase(s) and W dissolved in Cr23C6 phases.

Hardness tests have shown a 15% increase in hardness after laser re-melting but no noticeable variation with laser power (after re-melting hardness=390-425 HV2.5; cast material=300-360 HV2.5.

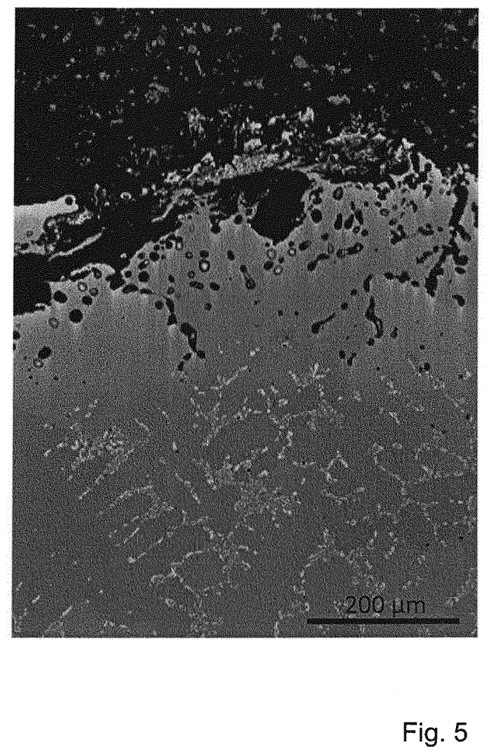

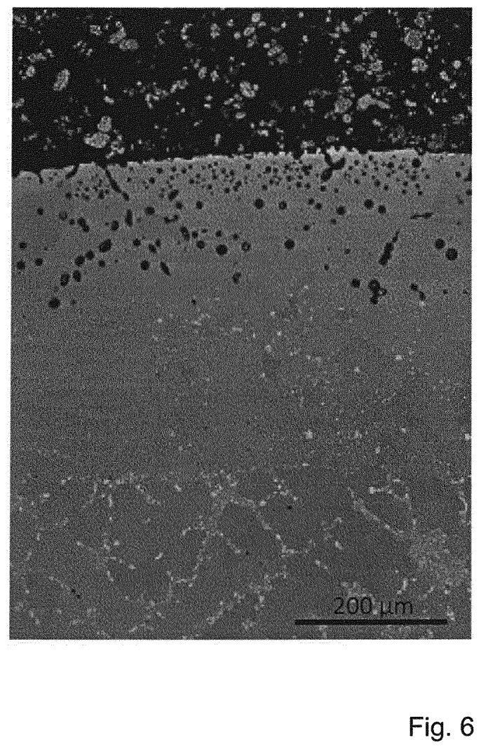

Isothermal testing was conducted using a simple heat induction furnace at ambient air and pressure at a temperature of 1200° C. for up to 8 days. During this thermal testing, an upper part of the re-melted layer developed porosity with the remainder of the layer unaffected. FIGS. 5 and 6 shown a comparison of porosities formed on re-melted and untreated surfaces.

1. A method for a laser surface treatment of furnace furniture of a heating furnace, which furnace furniture is used for the support of metal products in the heating furnace, wherein the furnace furniture is made of a creep resistant Ni—Cr alloy, the method comprising the steps of:
setting a laser device to generate a laser beam of a pre-defined power in a range sufficient to deliver a fluence in a range of 1.3×10⁶-1.3×10⁸ J/m²,
guiding the laser beam over the surface of the furnace furniture with a pre-defined velocity, such that the surface of the furnace furniture is heated locally to above its melting temperature.

2. The method according to claim 1, wherein the laser device and/or the laser beam and the furnace furniture are moved with respect to each other.

3. The method according to claim 1, wherein one or more laser devices are used to generate multiple laser beams.

4. The method according to claim 1, wherein the laser beam or multiple laser beams are each guided in a single track or in multiple tracks over the surface of the furnace furniture.

5. The method according to claim 4, wherein the tracks of the laser beam or laser beams run parallel to each other.

6. The method according to claim 4, wherein adjacent tracks of the laser beam or laser beams overlap.

7. The method according to claim 4, wherein the laser device or the laser devices are controlled such that the generated laser beam or laser beams result in tracks with a width in a range of 1-6 mm.

8. The method according to claim 4, wherein the overlap of adjacent tracks of the laser beam or laser beams is in the range of 20-80%.

9. The method according to claim 1, wherein continuous or pulsed laser beam or laser beams are used.

10. The method according to claim 1, wherein the velocity of the movement of the laser beam or the laser beams and the furnace furniture with respect to each other is in a range of 5-100 mm/s.

11. The method according to claim 1, wherein the velocity of the movement of the laser beam or the laser beams and the furnace furniture with respect to each other is in the range of 5-50 mm/s.

12. The method according to claim 1, wherein the laser surface treatment is carried out under a protective atmosphere.

13. The method according to claim 10, wherein the protective atmosphere is an argon atmosphere.

14. The method according to claim 1, wherein the furnace furniture is made from Ni—Cr alloys wherein the Ni+Cr content is in a range of 50-90%.

15. The method according to claim 1, wherein the laser surface treatment is followed by a mechanical surface treatment.

16. The method according to any of claim 4, wherein the laser device or the laser devices are controlled such that the generated laser beam or laser beams result in tracks with a width in a range of 2-5 mm.

17. The method according to any of claim 4, wherein overlap of adjacent tracks of the laser beam or laser beams is between 40-80%.

18. The method according to any of claim 4, wherein overlap of adjacent tracks of the laser beam or laser beams is between 60-70%.

19. The method according to claim 1, wherein the furnace furniture is made from Ni—Cr alloys wherein the Ni+Cr content is in a range of 75-85%.

20. The method according to claim 5, wherein adjacent tracks of the laser beam or laser beams overlap.
